(19) United States
(12) Patent Application Publication
(10) Pub. No.: US 2015/0113331 A1
(43) Pub. Date: Apr. 23, 2015

(54) SYSTEMS AND METHODS FOR IMPROVED SOFTWARE TESTING PROJECT EXECUTION

(71) Applicants: Sourav Sam Bhattacharya, Fountain Hills, AZ (US); Alka Garg, Redmond, WA (US); Anoop Rajan Rajan, Bellevue, WA (US)

(72) Inventors: Sourav Sam Bhattacharya, Fountain Hills, AZ (US); Alka Garg, Redmond, WA (US); Anoop Rajan Rajan, Bellevue, WA (US)

(73) Assignee: Wipro Limited, Bangalore (IN)

(21) Appl. No.: 14/056,932

(22) Filed: Oct. 17, 2013

(51) Int. Cl. G06F 11/36

(52) U.S. Cl. CPC G06F 11/3688
USPC 714/38.1

(57) ABSTRACT

This disclosure relates generally to software development, and more particularly to systems and methods for improved software testing project execution. In one embodiment, a software testing system is disclosed, comprising: a processor; and a memory storing processor-executable instructions comprising instructions for: obtaining a software test execution request including one or more software test cases to execute; identifying one or more software test environmental parameters; determining one or more computing systems for performing software test execution, based on the one or more software test environmental parameters; generating one or more configuration settings associated with initiating or terminating software test execution on the one or more computing systems; and storing the one or more configuration settings.

### TECHNICAL FIELD

This disclosure relates generally to software development, and more particularly to systems and methods for improved software testing project execution.

### BACKGROUND

In the field of software development, a software product usually undergoes a software development life cycle. Specifically, testing usually follows software programming or coding to achieve reliability and quality of software and ultimately customer satisfaction in a competitive business environment. Features like reliability and quality are attributed to software that has no defects or bugs. Such defects or bugs can cause feature lapse or accrue undesired deficiencies. Testing or debugging usually fixes defects or bugs in software. Typically, a software-testing project may have numerous test cases to execute, ranging from few hundreds to many thousands. In current practice, executing such numerous test cases may take a lot of time (sometimes months), and thus may impact software development time and cost. For example, a software-testing project involving a large mathematical computation can run for months.

Often test cases fail and require a restart. As an example, if a shell scripter in the process of making a batch file may go into a hung mode. Currently, one or more software testers continuously monitor the status of the test cases and take appropriate action at the right moment. Such techniques are prone to subjectivity in immediate detection of test case failures or hung situation, and face scalability issues for an enterprise project.

### SUMMARY

In one embodiment, a software testing system is disclosed, comprising: a processor; and a memory storing processor-executable instructions comprising instructions for: obtaining a software test execution request including one or more software test cases to execute; identifying one or more software test environmental parameters; determining one or more computing systems for performing software test execution, based on the one or more software test environmental parameters; generating one or more configuration settings associated with initiating or terminating software test execution on the one or more computing systems; and storing the one or more configuration settings.

In one embodiment, a software testing method is disclosed, comprising: obtaining a software test execution request including one or more software test cases to execute; identifying one or more software test environmental parameters; determining one or more computing systems for performing software test execution, based on the one or more software test environmental parameters; generating one or more configuration settings associated with initiating or terminating software test execution on the one or more computing systems; and storing the one or more configuration settings.

In one embodiment, a non-transitory computer-readable medium is disclosed, storing computer-executable software testing instructions comprising instructions for: obtaining a software test execution request including one or more software test cases to execute; identifying one or more software test environmental parameters; determining one or more computing systems for performing software test execution, based on the one or more software test environmental parameters; generating one or more configuration settings associated with initiating or terminating software test execution on the one or more computing systems; and storing the one or more configuration settings.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an example software test execution solution architecture according to some embodiments.

FIG. 2 illustrates example components of a software test execution system according to some embodiments.

FIG. 3 is a detailed block diagram of an example software test execution solution architecture according to some embodiments.

FIGS. 4A-E is a flow diagram illustrating an example software test execution method according to some embodiments.

FIG. 5 is a block diagram of an exemplary computer system for implementing embodiments consistent with the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

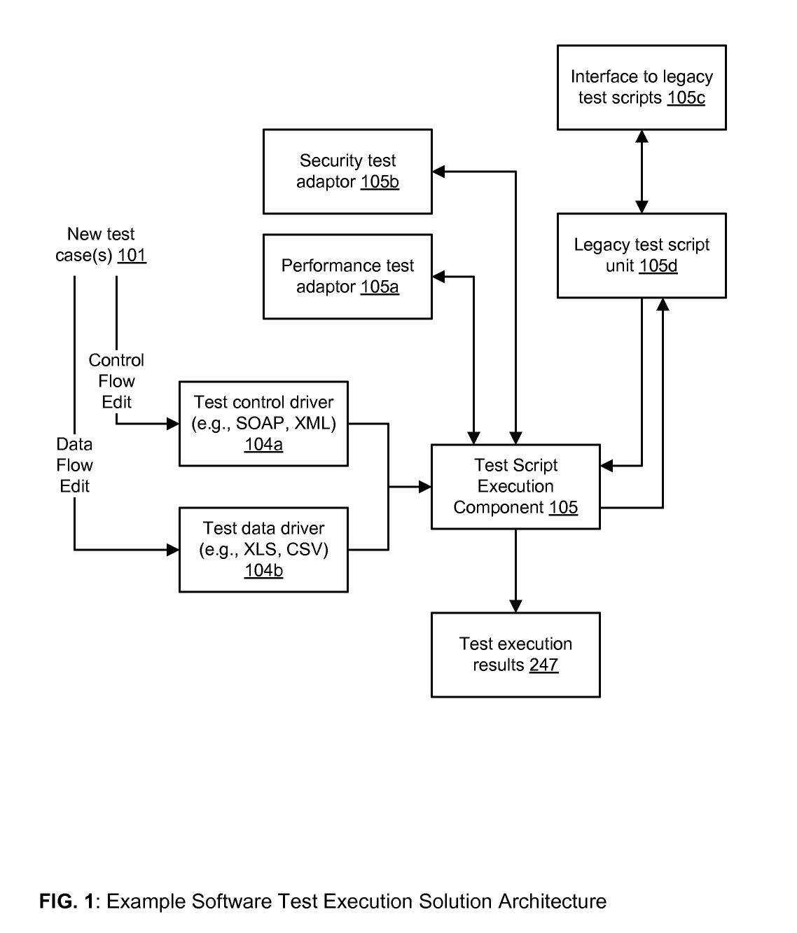

FIG. 1 is a block diagram of an example software test execution solution architecture according to some embodiments. In some embodiments, a software test execution system is provided that can facilitate automated execution of data driven test cases. Such test cases may be specific to an Application Programming Interface (“API”) under test, and may be customizable for each API. The system may be platform independent, and can, for example, scale according to the computing infrastructure utilized (e.g., for any number of web servers under test). The system may include built-in support for Authentication and token reuse, and may provide a direct feed to a Quality Control (“QC”) database or other such test defect repository. In some embodiments, the software test execution system may facilitate automated progress monitoring of test case execution, which may include success/completion monitoring, failover and skip support, and test results output audit preparation.

In some embodiments, the automated test execution solution may obtain a new test case 101, which may comprise both a control flow edit component and a data flow edit component. The control flow edit component may provide the parameters to control the flow of the testing process, whereas the data flow edit component may provide the data that is to be processed as part of test execution for each stage of the testing process. For example the new test case 101 may include a test script (e.g., as an XML file providing flow control instructions) which may be parsed by a test control driver 104a (e.g., using a SOAP parser). Using the flow control instructions, the test control driver may schedule and/or initiate the execution of one or more test scripts. The new test case 101 may include data (e.g., as XLS or CSV files) to be employed in the test execution. A test data driver 104b may parse the new test case 101 to extract the data to be utilized in the test, and may provide the data as needed to a test script execution component 105. The test script execution component 105 may process the test data using the test script provided to it, according to flow control instructions provided by the test control driver 104a. The performance test adaptor 105a, security test adaptor 105b, and legacy test script unit 105d and interface to legacy test scripts 105c, may be used for security testing, performance testing and adoption of any and all legacy test scripts, respectively. In some embodiments, the legacy test units themselves may not be part of the automated test execution solution; instead they may be ancillaries and can be enjoined to value add to the automated test execution solution.

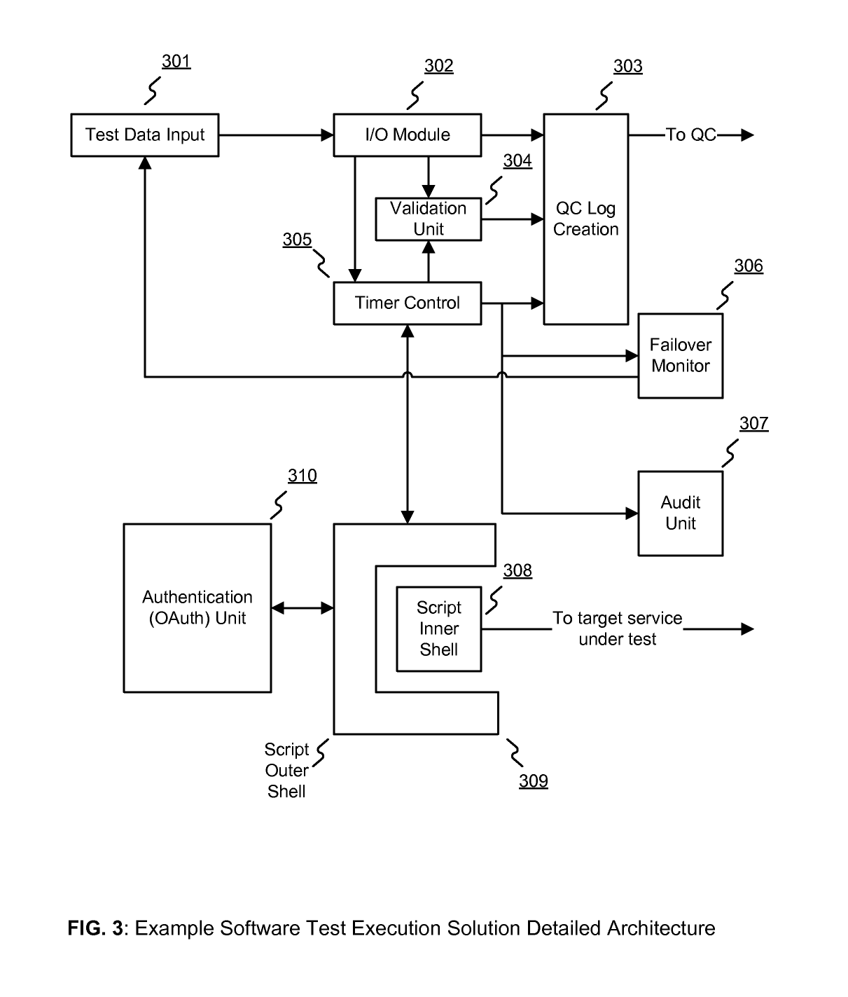

The performance test adapter 105a and the security test adapter 105b may be part of the automated test execution solution, and are described in further detail below with reference to FIG. 3. As an example, the security test adapter 105b may include security scanner tools, which may facilitate identification of security defects upon execution. These identification of defects may be passed through the test script execution component 105 as results output 247. Likewise, the performance test adapter 105a may include JMeter or Loadrunner scripts with traffic profiles that execute performance tests and pass through identification of test defects, similar to security testing. The legacy script modules, which for example may be pre-existing and already invested in by the owner of the software test solution architecture, may be readily integrated with the automated test execution solution. The test script execution component 105 may invoke the legacy test scripts, or the legacy test scripts may execute on their own and the results may be fed to the test script execution component 105. The test script execution component 105 may feed to the outputs generated in the automated test execution solution as test execution results 247, typically to a test defects repository such as a quality control relational database management system.

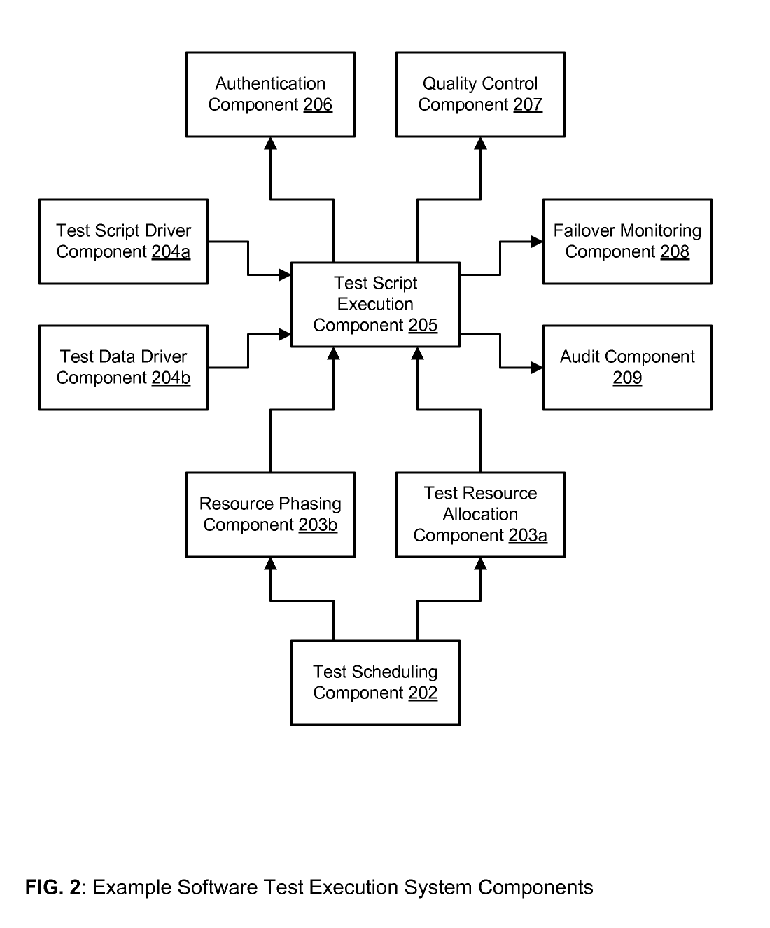

FIG. 2 illustrates example components of a software test execution system according to some embodiments. In some embodiments, a test scheduling component 202 may obtain a test case schedule (e.g., via manual input from a project manager), and may facilitate the scheduling of tests across various resources or assets (e.g., servers, computers, databases, etc.). In some embodiments, a test resource allocation component 203a may facilitate resource allocation, by obtaining input from the test scheduling component 202, determining the amount and type of resources required to perform the test execution, identifying assets across the globe (e.g., servers, computers, databases, etc.) to perform the test execution, and provide the test scripts/data for the assets to perform the test case execution.

In some embodiments, a resource phasing component 203b may initiate/trigger the processing by the resources/assets in a scheduled manner, according to the test case schedule as scheduled by the test scheduling component 202. The resource phasing component 203b may compute an optimum number of phased allocations for the test tasks. For example, a test case may be executed in multiple work shifts spread across time zones across the globe. Additional detail and pseudo-code regarding this component is discussed below with reference to FIG. 3.

In some embodiments, a test script driver component 204a may operate upon a master script (e.g., an XML file) to control execution flow for any and all test cases, one after another, using a set of common input entry values. For example, the test script driver component 204a may obtain, as input: (a) the name of the test script, (b) the code of the test script, (c) the list of input values to be used to execute the said test script, (d) the list of output values to which the test script response should be returned; and may allocate the test scripts, inputs and/or outputs to the resources performing the test execution across the globe. In an example implementation, this test script may read the above listed entry values from a table row, and the number of rows in the table may reflect the total number of test cases.

In some embodiments, a test data driver component 204b may provide the actual input data for the test scripts being executed by the resources. Fr example, the data may be in the form of a CSV (or, similar such delimited) table, which contains the full description of all the entry required for a test case execution in each row. The number of rows of data provided may match the total number of test cases. The very last row shall use a special delimiter to indicate the end of the table.

In some embodiments, a test script execution component 205 may execute the test cases. For example, the test script execution component 205 may be implemented as a global distributed- or grid-computing system. These scripts executed by the test script execution component 205 may formatted to a common skeleton structure, so that the same script can execute a list or large number of test cases by changing the data input to a common script. In some embodiments, the test scripts may include a core set of remote API request and response code, surrounded by API parameter input and output instructions.

In some embodiments, an authentication component 206 and quality control component 207 may be provided. The authentication component 206 may interface with the test script execution component 205. For example, in the case of testing a remote Application Programming Interface (“API”) applications, a user may first have to first login and authenticate user credentials before testing may proceed. After authentication by the user, the authentication component 206 may carry forward the session ID (or, some form of a token) for subsequent API calls. The quality control component 207 may serve as a repository for test results, quality control metric, or defects identified in the processing of any test script, or defects identified in any script.

In some embodiments, a failover monitoring component 208 may be provided. A failover monitoring component 208 may test for successful execution of each test case, e.g., focusing on test cases that hang (i.e., create an infinite loop) or lead to a denial-of-service (“DoS”) situation. The failover monitoring component 208 may also test for the test script failing and control flow leading to an exception generator. In some embodiments, the failover monitoring component 208 may ensure execution progresses through each one of the listed test cases, and should a previously scheduled test case fail or time-out or even abort, then the failover monitoring component 208 may ensure continued execution of the subsequent test cases.

In some embodiments, an audit component 209 may be provided. The audit component 209 may work in conjunction with the failover monitoring component 208. The audit component 209 may tally the percentage completion of the test cases, and creates status report for any internal or external audit. The audit component 209 may also provide reports for demonstrating adherence to software engineering standards.

FIG. 3 is a detailed block diagram of an example software test execution solution architecture according to some embodiments. In some embodiments, test data input 301 may provided via an I/O module 302 for test script execution. The test data input 301 may include, without limitation, an API name, a list of parameters (which can be a variable number), and terminated by a delimiter. In a specific implementation, the row may also contain the expected execution timespan of the API, which may be used to determine if the test case is hanging and requires an abort. The I/O module 302 may read the test data input 301, one row at a time, and prepare the test case for execution. This module may terminate when all the rows of the test data input 301 are exhausted.

In some embodiments, a timer control module 305 may receive an entire test case (e.g., a complete row from the test data input 301) and pass the test case to the script outer shell 309. This module may initiate a launch or start command for the test case to the script outer shell 309, recoding the start time of the test case, keep track of the current time as execution progresses, receive a response (if available within a fixed multiplier (N) of the expected execution timespan) returned from the script outer shell 309, and if no response is received within N*(expected execution timespan) then issue a kill command to the script outer shell 309. In this case, the test result may be neither Pass nor Fail, but an Abort. The statistics on Aborts may be sent to the failover monitor 306 and the audit unit 307.

In some embodiments, a validation unit 304 may receive output from the timer control module 305, in the event the test case completed (e.g., not Aborted). The validation unit 304 may compare the test case output with the expected value (in case real value, like integer or string, are provided), or the return code (indicating a success or failure). The validation unit 304 may write the test result into QC (or, a similar defect reporting database). In some embodiments, a script outer shell 309 may encapsulate the script inner shell 308, which runs the actual test case. The task of the script outer shell 309 may be to communicate with the timer control module 305, and upon command: start/launch the test case, kill the test case, and report a result from the test case completion back to the timer control module 305.

In some embodiments, a script inner shell 308 may perform the actual test case execution. It may receive the entire test case detail (API name, and parameters) from the script outer shell 309. In case of functional testing, it may form an HTTPS or HTTP request to the remote web service with the API name and parameters. In case of security testing, it may launch the security scanner on the API. In case of performance testing, it may pass the API name and parameters to a performance test tool, e.g., JMeter. This module may receive the return response from the test case execution, unless the script outer shell 309 issues a kill command in which case script inner shell 308 may kill the test case execution.

In some embodiments, an authentication unit 310 may provide a security token for all API calls (i.e., API test cases) after the authentication step. In an example operation, the first API to be tested may be the authentication API, which may generate the token, and report the token to the authentication unit 310. The authentication unit 310 may store the token for reuse in all subsequent API test case invocations.

In some embodiments, a failover monitor 306 may receive a list of Aborted test cases from the timer control module 305, and provide a user interface (“UI”) for a test engineer to manually review. After review, the test engineer may: decide to extend the expected execution time value and re-enter the test cases (with updated expected execution time value) in a test data input table, or forward it for manual drill-down, to investigate the root cause for unusually high execution time, or send the test case back to the timer control module 305 for a re-run if the expectation is that the previous iteration's prolonged execution time was a sporadic event and is unlikely to repeat. In some embodiments, an audit unit 307 may receive an Aborted test cases list from the timer control module 305, and produce statistics for review.

An execution method may commence by obtaining the test data input table 301 for each test case. The test data input table 301 may include API name and API parameters in each row, delimited by a chosen string and then followed by the expected execution time of the said API. The delimiter may demonstrate the ability to support a variable number of API parameters. The table may be populated by the output of Automated Test Data Generation algorithms. Rows from this table may be extracted by the I/O module 302, which may scan the test data input table 301 one row at a time, and continue doing so until the last row of the test data input table 301 is exhausted. The I/O module 302 may prepare one test case data in entirety and pass control onto the timer control module 305. The time control module 305 may start a clock, and issue a “commence execution” signal to the shell outer script 309. The timer control module 305 may also report the start time to an alert unit, which may be set to respond with a timeout alert at “(start+expected execution time)” time instant. If the timeout alert is reached, then the timer control module 305 may send a kill signal to the shell outer script 309. The shell outer script 309 may receive a start or kill command from the timer control module 305 and forward the same to the shell inner script 308. The shell inner script 308 may launch the actual test case, wherein the step of launching may include providing one of the following:
An HTTPS or HTTP request for platform independent API functional test
An prepackage XML envelope with internal parameters formatted per the API name and parameters, in a platform specific API functional test
Command passed to a security scanner, with API specific details, for security test.
Command passed to a performance test module, with API specific details, for performance test.

If the shell inner script 308 completes the test case execution, regardless of Pass or Fail outcome, then it may send the return response to shell outer script 309, which in turn may relay the output to the timer control module 305, which may carry it forward to the validation unit 304. The validation unit 304 may compare the expected output, either in value equality or in return code assessment—and reports a Pass/Fail status to the Defect Table, e.g., the QC. Finally, if the timer control module 305 sends a kill signal to the shell outer script 309 (indicating a timeout), then a status message may be sent to the audit unit 307. The audit unit 307 may be responsible for preparation of Abort statistics for review. At the same time, the Abort message may also be sent to a failover monitor 306. The failover monitor 306, upon receipt of the Abort message, may involve a human test engineer who can either retry running the same test cases by sending it to the timer control module 305 (anticipating a sporadic failure), or re-adjust the expected expiration time to a higher value and reset the data back to the test data input table 301 table, or abandon the test case for manual drill down and offline processing.

In some embodiments, the timer control module 305's may commission (i.e., issue, or Start) each test task and then monitor the elapsed time. If the elapsed time exceeds a threshold, indicating the test task may have exceeded a time-out and may be hanging in an infinite loop—then the timer control module 305 may abort the test task execution and report the same to the failover monitor 306 and the audit unit 307. On the other hand, if the test task completes successfully, then the validation unit 304 may match the output with the expected value and declares a test case outcome: Pass or Fail. The QC log creation unit 303 may collect the test result, along with the test input to create a QC entry. The QC entry may include the API name, test input data (i.e., API parameters), priority value, expected output, actual output, Pass or Fail status, and any comment that may be generated by the timeliness of execution as reported by the Timer Control unit. The authentication unit 310 may implement an SSO or OAuth solution. In some embodiments, the authentication unit 310 may be specific to the API and platform under test.

The script outer shell 309 may be a messaging application that exchanges messages to/from the other components. The script inner shell 308 may be a language specific script that can request/response with the target Web Service under test. It may also include launching test specific tools, e.g., performance testing tool or security testing tool.

The following lists a pseudo-code for computing average concurrency in the test cases' precedence graph. Based on the average concurrency computation, a number of phase shifts to organize and schedule the resources may be computed. Although, this result is presented for software test cases execution, it can be generalized for other floor shop scheduling, e.g., for machine shops, manufacturing, customer service call center and BPO and the like.

Begin
For each test case (TC_i) Do

Compute Earliest_Start_Time (TC_i)
Compute Latest_Start_Time (TC_i)
Average_Start_Time (TC_i)

= [Earliest_Start_Time (TC_i) + Latest_Start_Time (TC_i) ] / 2
/* This is a simplistic mid-point averaging. Can be generalized. */

Average_End_Time (TC_i) = Average_Start_Time (TC_i)

+ Duration (TC_i)

EndFor

Max_MakeSpan = 0;
For i = 1 to N Do /* N = total number of test cases */

Max_MakeSpan = Max_MakeSpan + Duration (TC_i);
EndFor

For i = 1 to N Do

For time = 1 to Max_MakeSpan DO

Allocation [i, time] = 0
If (time >= Average_Start_time (TC_i)) and

(time < Average_Start_time (TC_i) + Duration (TC_i))

Then Allocation [i, time] = 1;

EndIf
EndFor

EndFor

For time = 1 to Max_MakeSpan DO

Count[time] = 0
For i = 1 to N DO

Count[time] = Count[time] + Allocation[i, time];
EndFor

EndFor

TotalCount = 0;
time = 0;
Repeat

time = time + 1;
TotalCount = TotalCount + Count[time];

Until Count[time] == 0
Avg_Councurrency = TotalCount / N;
No_of_Phase_Shifts = Ceiling ( M / Avg_Concurrency);
No_Resources_per_Shift = Floor ( M / No_of_Phase_Shifts );

End

Embodiments of the current test execution automation system and method are designed for test cases that are API based and intended to execute at a remote web service. However, the disclosure is not restricted to API based text execution only. It can be generalized to a non-API based execution environment as well, e.g., a client-server model where the client is sending messages (not only API calls, but regular messages also) to the server to execute test cases. In such embodiments, the API names (in the Test Data Input Unit) may be replaced with service message names, and the API parameter list shall be replaced with service parameters. Any IPO (input-processing-output) based software execution can be incorporated in the embodiment, wherein the Input (e.g., called service name and list of parameters) may be used in the Test Data Input unit, and is not necessarily restricted to a web services API call).

In some embodiments, in FIG. 3, the connection between the Failover Monitor Unit 306 and Test Data Input Unit 301 may be an immediate feedback loop, i.e., a test case marked “Aborted” may be immediately moved back to the Test Data Input entry queue. And such a concept may be generalized. In such a generalization, a Dashboard may be connected to the two aforesaid Units. A human test engineer may be able to track the flow of the test cases that enter the Failover Monitor Unit, and may choose to: (a) shelve the test case; (b) immediately send a test case back to the Test Data Input Unit; or (c) create multiple priority groupings amongst the test cases and assign the aborted test cases into a respective priority group. A separate queue may be maintained for each priority group. The embodiment shown in FIG. 3 may be considered an implementation with a single priority group and instantaneous transfer of the aborted test cases to re-enter the Test Data Input Unit. The generalization can extend to (a) multiple priority levels, and (b) non-zero, finite delay element prior to a re-attempted execution of a previously aborted test case, etc.

In FIG. 3, the Timer Control Unit (box 305) may be designed to monitor the elapsed time of the test case, and if the elapsed time exceeds a pre-defined threshold, to mark the test cases as “Abort”. A generalization of the time-based abort characterization can be made as follows: A test case may be considered hanging, or not making any significant progress, by observing other abnormalities of the underlying system. Other abnormalities include, but are not limited to: CPU load, Memory consumption, Disk utilization, Network traffic delay, failure to provide user input, and/or any other reasons for computing delay. The Timer Control Unit (box 305) can be extended to be a system resource monitor. If any one or more of the system resource(s) is detected to exceed a threshold then the test case (who execution presumably is causing the system load) may be aborted. The system resource monitor can be combined with a timer threshold monitor (in an OR relationship), so that both system resource under-utilization and time exceeding a threshold can be jointly detected.

In FIG. 3, the Validation Unit 304 may be designed to validate the output in a functional computation, e.g., ensuring the test data Output from the actual execution matches with a predefined Output table, which may store the expected output value. Although pre-dominantly functional, the test data output may also be extended to include result codes, error codes and messages—e.g., not only functional value outputs. Some IPO (input-processing-output) applications may have non-numeric output values, and in such cases the Validation Unit may consider call return codes, error codes, message strings, etc.

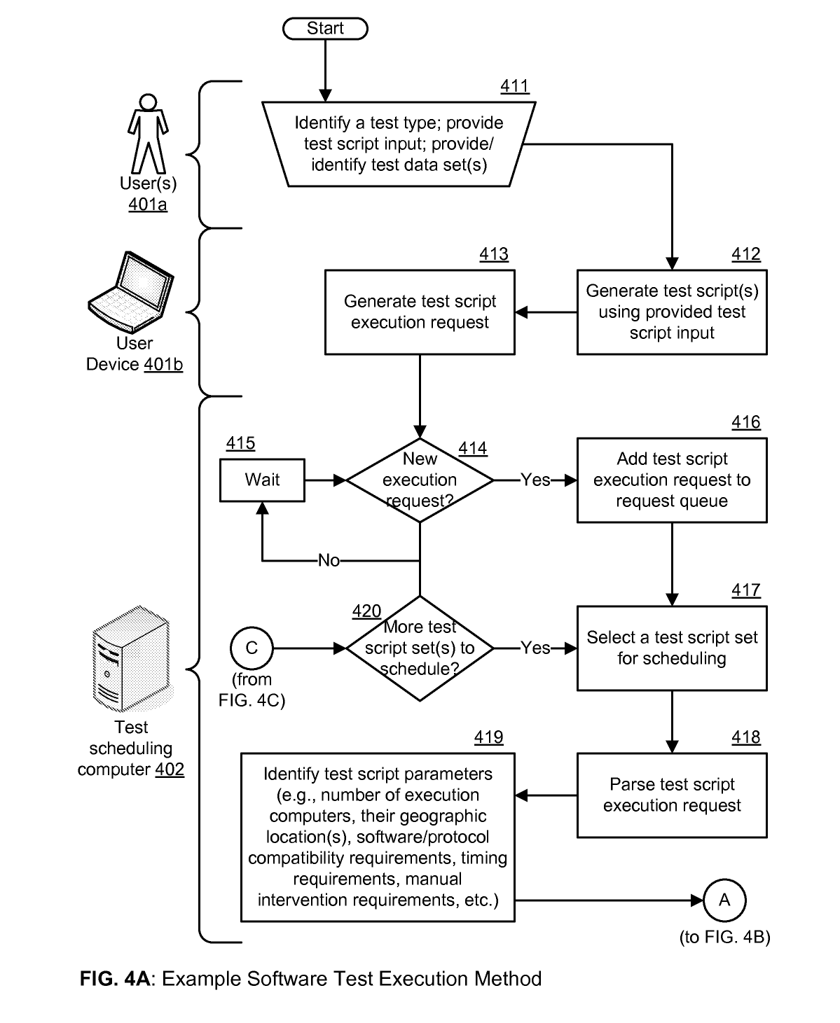

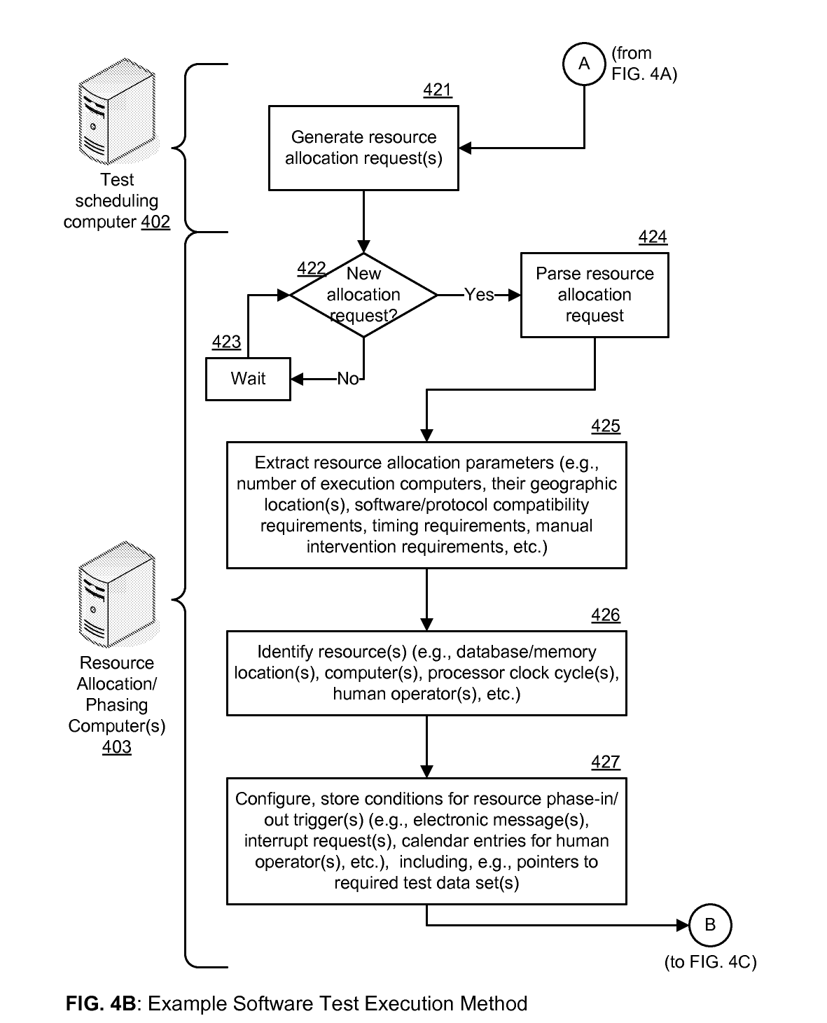

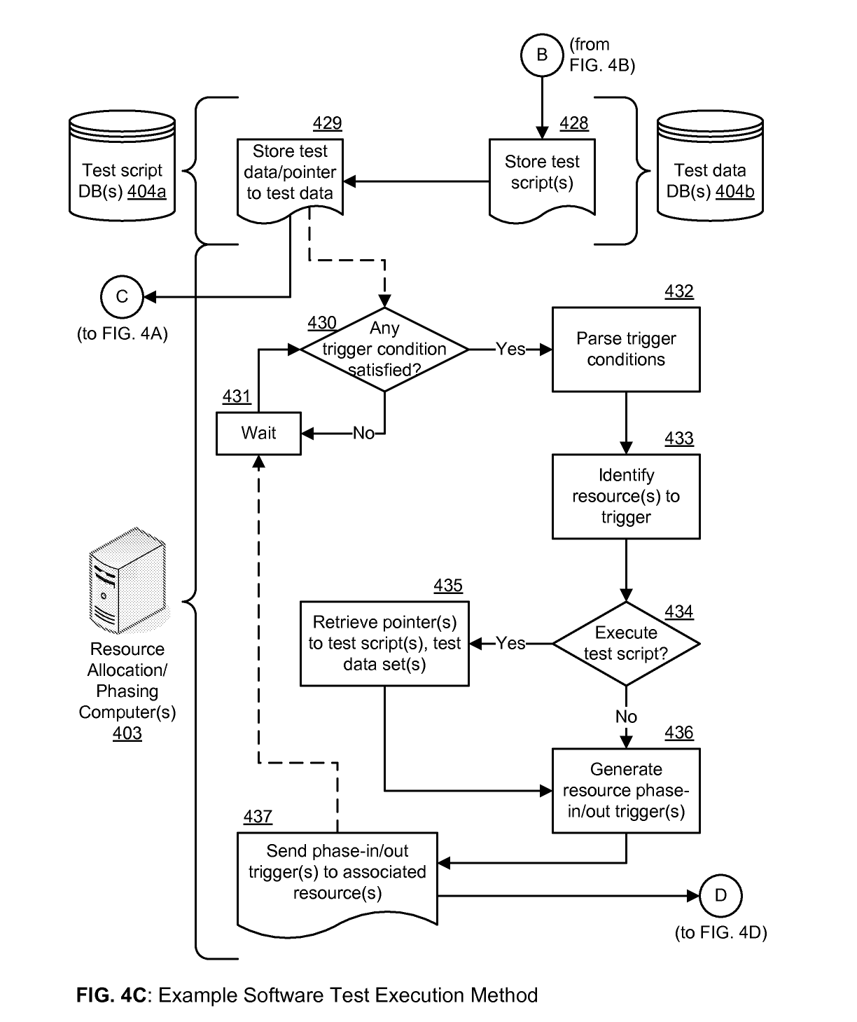

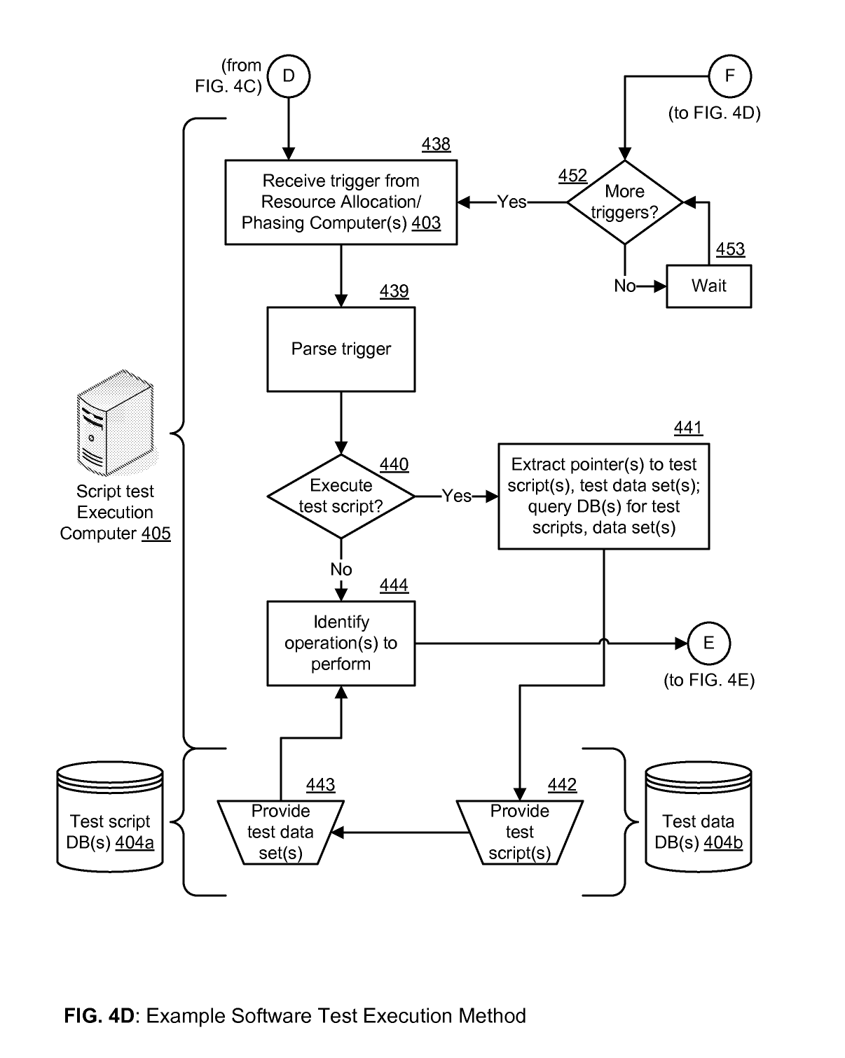

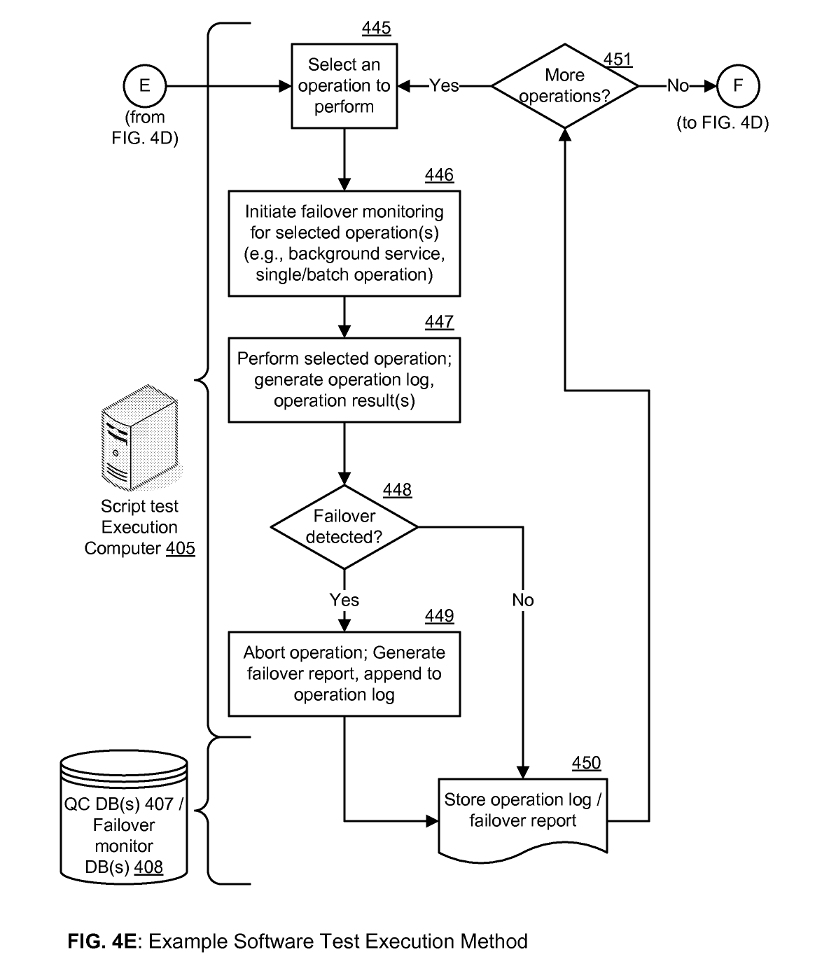

FIGS. 4A-E is a flow diagram illustrating an example software test execution method according to some embodiments. With reference to FIG. 4A, in some embodiments, one or more users 401a may identify a test type, provide a test script input, and provide or identify test data set(s) to apply for the test into a user device, 411. A user device 401b may generate test script(s) using provided test script input, 412, and generate a test script execution request using, 413. The user device may provide the test execution script request to a test scheduling computer 402. The test scheduling computer 402 may be configured to wait for any new execution request (see 415). Upon receiving a new test execution request (see 414), the test scheduling computer 402 may add the test script execution request to a request queue, 416. The test scheduling computer 402 may select a test script set for scheduling, 417, and parse the test execution request, 418. Based on the parsing, the test scheduling computer 402 may identify test script parameters (e.g., number of execution computers, their geographic location(s), software/protocol compatibility requirements, timing requirements, manual intervention requirements, etc.) for the text script corresponding to the selected test execution request, 419.

With reference to FIG. 4B, in some embodiments, the test scheduling computer 402 may generate resource allocation requests using the test script parameters, 421, and provide the resource allocation requests to one or more resource allocation/phasing computers 403. A resource allocation/phasing computer 403 may wait for an identify a new allocation request (see 422-423), and parse the resource allocation request, 424. The resource allocation/phasing computer 403 may extract resource allocation parameters (e.g., number of execution computers, their geographic location(s), software/protocol compatibility requirements, timing requirements, manual intervention requirements, etc.) from the resource allocation request based on the parsing step, 425. The resource allocation/phasing computer 403 may identify resource(s) (e.g., database/memory location(s), computer(s), processor clock cycle(s), human operator(s), etc.), according to the resource allocation parameters, to satisfy the resource allocation request, 426. Further, the resource allocation/phasing computer 403 may configure and store conditions for resource phase-in/out trigger(s) (e.g., electronic message(s), interrupt request(s), calendar entries for human operator(s), etc.), including, e.g., pointers to required test data set(s), 427.

With reference to FIG. 4C, in some embodiments, a test script database 404a may store the test scripts, 428, and may also store test data and/or one or more pointers to the test data, if stored elsewhere, 429. The resource allocation/phasing computer 403 may wait and check if any trigger condition for either phasing in or phasing out a resource is satisfied (see 430-431). If a trigger condition is satisfied, the resource allocation/phasing computer 403 may parse the trigger conditions, 432, and may identify the resource(s) to trigger based on the parsing, 433. The resource allocation/phasing computer 403 may determine whether a test script should be executed (see 434), and if so, may retrieve a pointer to the test script(s) and/or test data set(s) for test script execution, 435. The resource allocation/phasing computer 403 may generate a resource phase-in/out trigger, 436, and send the phase-in/out trigger to the appropriate resource(s), 437.

With reference to FIG. 4D, in some embodiments, a script test execution computer 405 may receive a trigger from the resource allocation/phasing computer 403. The script test execution computer 405 may parse the trigger, 439, and may determine whether to execute a test script (see 440). If the script test execution computer 405 determines that a test should be performed, the script test execution computer 405 may extract pointer(s) to the test script(s), test data set(s), 441, and may query a database for the test scripts and data sets (see 442-443). The script test execution computer 405 may identify the operations to perform, 444.

With reference to FIG. 4E, in some embodiments, the script test execution computer 405 may select an operation to perform as part of test script execution, 445. The script test execution computer 405 may initiate failover monitoring for the selected operation (e.g., as a background service), 446. The script test execution computer 405 may perform the selected operation, and generate an operation log and/or operation results, 447. If the script test execution computer 405 detects a failover condition (see 448), the script test execution computer 405 may abort the operation, generate a failover report, and append the failover report to an operation log, 449. The script test execution computer 405 may store the operation log, results, and any failover report in a QC database 407 and/or failover monitor database 408. The script test execution computer 405 may perform such procedures iteratively on an ongoing basis (see FIG. 4E, 451; FIG. 4D, 452). Although FIG. 4E depicts sequential processing and failover monitoring of operations, it is to be understood that such operations may be performed in a parallel or massively parallel manner (e.g., using multiple threads, multiple processors, grid computing, distributed computing, etc.).

### Computer System

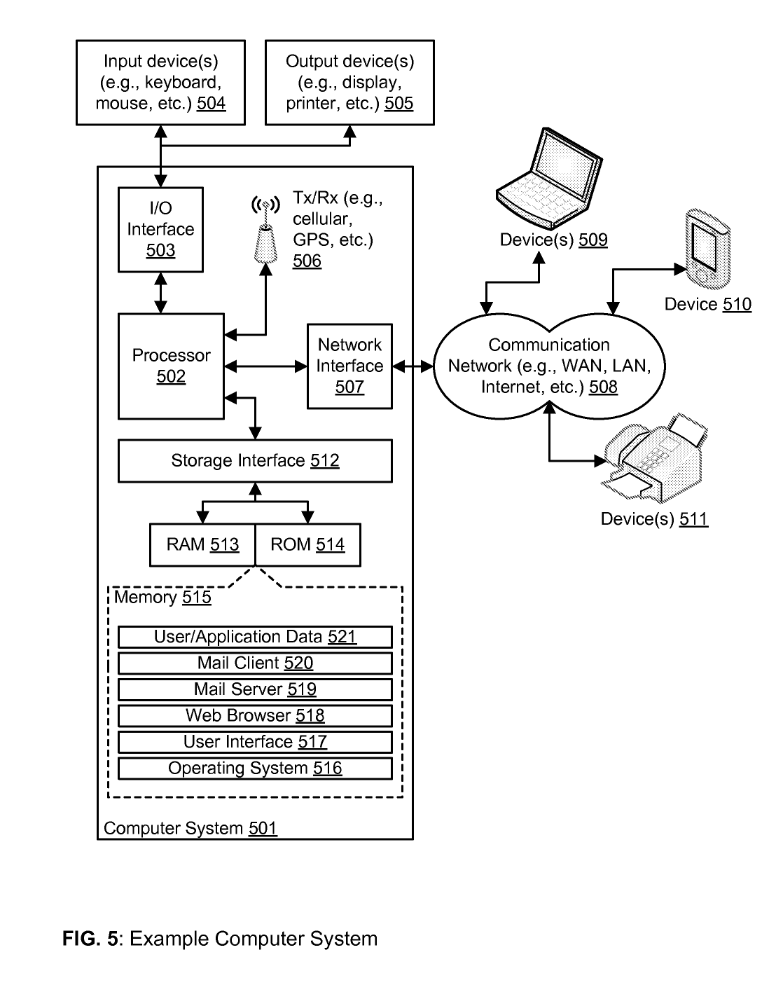

FIG. 5 is a block diagram of an exemplary computer system for implementing embodiments consistent with the present disclosure. Variations of computer system 501 may be used for implementing user device 401b, test scheduling computer 402, resource allocation/phasing computer(s) 403, test script execution computer 405, etc. Computer system 501 may comprise a central processing unit (“CPU” or “processor”) 502. Processor 502 may comprise at least one data processor for executing program components for executing user- or system-generated requests. A user may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 510, 511, and 512. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, test script database(s) 404a, test data database(s) 404b, quality control database(s) 407, failover monitor database(s) 408, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., test scheduling component 102, test resource allocation component 103a, resource phasing component 103b, test script driver component 104a, test data driver component 104b, test script execution component 105, authentication component 106, quality control component 107, failover monitoring component 108, audit component 109, test control driver 204a, test data driver 204b, performance test adaptor 205a, security test adaptor 205b, interface to legacy test scripts 205c, legacy test script unit 205d, I/O module 302, QC log creation module 303, validation unit 304, timer control 305, failover monitor 306, audit unit 307, script inner shell 308, script outer shell 309, authentication (OAuth) unit 310, etc.) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

The specification has described systems and methods for improved software testing project execution. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A software testing system, comprising:
a processor; and
a memory storing processor-executable instructions comprising instructions for:
obtaining a software test execution request including one or more software test cases to execute;
identifying one or more software test environmental parameters;
determining one or more computing systems for performing software test execution, based on the one or more software test environmental parameters;
generating one or more configuration settings associated with initiating or terminating software test execution on the one or more computing systems; and
storing the one or more configuration settings.

2. The system of claim 1, wherein the one or more software test environmental parameters includes at least one of: a geographic location of one or more computing systems; a time zone of one or more computing systems; a labor availability parameter; an energy price parameter; or a labor cost parameter.

3. The system of claim 1, the instructions further comprising instructions for:
providing a notification with a recommended number of job sites to execute the test project, and furthermore providing a notification to at least one of the one or more computing systems to initiate software test execution, based on at least one of the stored configuration settings.

4. The system of claim 3, wherein the software test execution is configured for performing a functional test combined with a plurality of non-functional tests, including at least one of: a security test; or a performance test.

5. The system of claim 3, the instructions further comprising instructions for:
monitoring progress of the software test execution;
identifying a failover condition based on monitoring the progress of the software test execution;
terminating automatically the software test execution and initiating a next software test execution from a batch;
generating a report based on identifying the failover condition; and
storing the generated report.

6. The system of claim 5, wherein monitoring progress of the software test execution is performed by a standalone utility executed by the processor.

7. The system of claim 1, wherein at least one of the one or more configuration settings includes a calendar data object configured for alerting a user.

8. The system of claim 3, the instructions further comprising instructions for:
providing a notification of a storage location of a test script associated with the software test execution; and
providing a notification of a result of a batch-processed test script being uploaded to a test results database.

9. A software testing method, comprising:
obtaining a software test execution request including one or more software test cases to execute;
identifying one or more software test environmental parameters;
determining one or more computing systems for performing software test execution, based on the one or more software test environmental parameters;
generating one or more configuration settings associated with initiating or terminating software test execution on the one or more computing systems; and
storing the one or more configuration settings.

10. The method of claim 9, wherein the one or more software test environmental parameters includes at least one of: a geographic location of one or more computing systems; a time zone of one or more computing systems; a labor availability parameter; an energy price parameter; or a labor cost parameter.

11. The method of claim 9, further comprising:
providing a notification with a recommended number of job sites to execute the test project, and furthermore providing a notification to at least one of the one or more computing systems to initiate software test execution, based on at least one of the stored configuration settings.

12. The method of claim 11, wherein the software test execution is configured for performing a functional test combined with a plurality of non-functional tests, including at least one of: a security test; or a performance test.

13. The method of claim 11, further comprising:
monitoring progress of the software test execution;
identifying a failover condition based on monitoring the progress of the software test execution;
terminating automatically the software test execution and initiating a next software test execution from a batch;
generating a report based on identifying the failover condition; and
storing the generated report.

14. The method of claim 13, wherein monitoring progress of the software test execution is performed by a standalone utility executed by the processor.

15. The method of claim 9, wherein at least one of the one or more configuration settings includes a calendar data object configured for alerting a user.

16. The method of claim 11, further comprising:
providing a notification of a storage location of a test script associated with the software test execution; and
providing a notification of a result of a batch-processed test script being uploaded to a test results database.

17. A non-transitory computer-readable medium storing computer-executable software testing instructions comprising instructions for:
obtaining a software test execution request including one or more software test cases to execute;
identifying one or more software test environmental parameters;
determining one or more computing systems for performing software test execution, based on the one or more software test environmental parameters;
generating one or more configuration settings associated with initiating or terminating software test execution on the one or more computing systems; and
storing the one or more configuration settings.

18. The medium of claim 17, wherein the one or more software test environmental parameters includes at least one of: a geographic location of one or more computing systems; a time zone of one or more computing systems; a labor availability parameter; an energy price parameter; or a labor cost parameter.

19. The medium of claim 17, the instructions further comprising instructions for:
providing a notification with a recommended number of job sites to execute the test project, and furthermore providing a notification to at least one of the one or more computing systems to initiate software test execution, based on at least one of the stored configuration settings.

20. The medium of claim 19, wherein the software test execution is configured for performing a functional test combined with a plurality of non-functional tests, including at least one of: a security test; or a performance test.

21. The medium of claim 19, the instructions further comprising instructions for:
monitoring progress of the software test execution;
identifying a failover condition based on monitoring the progress of the software test execution;
terminating automatically the software test execution and initiating a next software test execution from a batch;
generating a report based on identifying the failover condition; and
storing the generated report.

22. The medium of claim 21, wherein monitoring progress of the software test execution is performed by a standalone utility executed by the processor.

23. The medium of claim 17, wherein at least one of the one or more configuration settings includes a calendar data object configured for alerting a user.

24. The medium of claim 19, the instructions further comprising instructions for:
providing a notification of a storage location of a test script associated with the software test execution; and
providing a notification of a result of a batch-processed test script being uploaded to a test results database.
